(19) United States
(12) Patent Application Publication
(10) Pub. No.: US 2002/0076175 A1
(43) Pub. Date: Jun. 20, 2002

(54) Packaging for fiber optic devices

(75) Inventors: Michael A. Centanni, Parma, OH (US); Ernest J. Sessa, Monkton, MD (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Gould Optronics Inc.

(21) Appl. No.: 09/824,934

(22) Filed: Apr. 3, 2001

Related U.S. Application Data
(63) Continuation-in-part of application No. 09/737,884, filed on Dec. 15, 2000.

(51) Int. Cl. G02B 6/36

(52) U.S. Cl. 385/99; 385/134

(57) ABSTRACT

A package for a fiber optic device or component comprised of an elongated support substrate for supporting an optical device or component having at least one optical fiber extending therefrom. The optical fiber has an inner glass core and a glass cladding surrounded by an outer buffer. An elongated glass tube is dimensioned to receive the support substrate. The glass tube has open ends. The at least one optical fiber extends through one of the open ends with the outer buffer removed from the optical fiber in the vicinity of the open end. A glass seal surrounds the inner glass fiber closing the open ends.

### FIELD OF THE INVENTION

The present invention relates to packaging for fiber optic devices or components such as couplers, splitters, sensors and the like, and more particularly to a fiber optic package that hermetically seals the optical device or component from external environmental conditions.

### BACKGROUND OF THE INVENTION

The wide spread and global deployment of fiber optic networks and systems mandates that fiber optic equipment and components operate reliably over long periods of time. This mandate imposes stringent performance requirements on various fiber optic components that are used in such networks and systems. In this respect, since fiber optic components are expected to operate reliably in hostile environments, prior to qualification for use, such components are typically subjected to an array of mechanical and environmental tests that are designed to measure their performance. One of these tests is a damp/heat soak test, wherein a fiber optic component or device is exposed to elevated temperature and humidity conditions (typically 85° C. and 85% relative humidity) for an extended period of time. Fiber optic couplers exposed to such conditions may exhibit a gradual drift in insertion loss. Eventually this drift will cause a coupler to exceed its assigned performance specifications.

It is believed that the primary cause for the above-identified drift is water vapor or some component, constituent or by-product of water vapor diffusing into the exposed core glass of the coupler and changing its index of refraction. In an attempt to prevent migration of moisture into the coupling region, it has been known to package fiber optic couplers and other fiber optic components inside a metal tubing and to seal the ends of the tubing with a polymeric material, such as a silicon-based material or epoxy. These types of materials have not proved successful in preventing the aforementioned problem.

The present invention overcomes these and other problems and provides a packaging for a fiber optic component or device, wherein the optic component or device is totally enclosed within a glass structure.

### SUMMARY OF THE INVENTION

In accordance with the present invention, there is provided a package for a fiber optic device or component comprised of an elongated support substrate for supporting an optical device or component having at least one optical fiber extending therefrom. The optical fiber has an inner glass core and a glass cladding surrounded by an outer buffer. An elongated cover is dimensioned to mate with the support substrate to define an elongated passage to encase the optical device or component between the substrate and cover. The passage has open ends and a seam where the cover mates with the support substrate. The at least one optical fiber extends through one of the open ends with the outer buffer removed from the optical fiber in the vicinity of the open end. Optionally, the buffer may not be removed from the at least one optical fiber. A glass seal extends along the seam and surrounds the inner glass fiber closing the open ends.

It is an object of the present invention to provide packaging for a fiber optic component or device.

It is an object of the present invention to provide packaging as described above for a fiber optic component or device including generally continuous optical fibers.

It is another object of the present invention to provide packaging for a fiber optic coupler.

Another object of the present invention is to provide packaging as described above that hermetically seals the fiber optic component or device from the surrounding environment.

Another object of the present invention is to provide packaging as described above that does not require the use of precision components to achieve hermetic sealing of the optical fibers.

A still further object of the present invention is to provide packaging as described above that retards or prevents slow drift in insertion loss in couplers due to damp/heat environments.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein.

FIG. 1 is a sectioned, top plan view of a package for a fiber optic device or component, illustrating a preferred embodiment of the present invention;

FIG. 2 is a sectional view taken along lines 2-2 of FIG. 1;

FIG. 3 is a sectional view taken along lines 3-3 of FIG. 2;

FIG. 4 is a sectional view taken along lines 4-4 of FIG. 2;

FIG. 5 is a sectional view taken along lines 5-5 of FIG. 2;

FIG. 6 is a sectional view taken along lines 6-6 of FIG. 2;

FIG. 6A is an exploded view showing, in cross-section, housing sections prior to assembly;

FIG. 6B is a view showing in cross-section housing sections after assembly;

FIG. 7A is a cross-sectional view of a housing showing a glass-based composition encasing the bottom thereof, illustrating another embodiment of the present invention;

FIG. 8 is a sectioned, top view of a package for a fiber optic device or component, illustrating another embodiment of the present invention;

FIG. 9 is a sectional view taken along lines 9-9 of FIG. 8;

FIG. 10 is an exploded, perspective view of a housing for the package shown in FIG. 1;

FIG. 11 is an enlarged, perspective view of one end of a housing in accordance with one aspect of the present invention;

FIG. 12 is a partially sectioned, top plan view of one end of a package for a fiber optic device or component, the other end being essentially a mirror image thereof, illustrating another embodiment of the present invention;

FIG. 13 is a sectional, elevational views of the package shown in FIG. 12;

FIG. 14 is an enlarged, sectional view taken along lines 14-14 of FIG. 13;

FIG. 15 is an enlarged, sectional view taken along lines 15-15 of FIG. 13;

FIG. 16 is a partially sectioned, perspective view of the package shown in FIG. 12;

FIG. 17 is a sectional, elevational view of the package shown in FIG. 12, schematically illustrating a method of forming a barrier within the package;

FIG. 18 is a partially sectioned, top plan view of one end of a package for a fiber optic device or component, the other end being essentially a mirror image thereof, illustrating another embodiment of the present invention;

FIG. 19 is a sectional, elevational view of the package shown in FIG. 18;

FIG. 20 is an enlarged, sectional view taken along lines 20-20 of FIG. 19;

FIG. 21 is a side, elevational view schematically illustrating assembly of the package shown in FIGS. 18-20;

FIG. 22 is an enlarged, sectional view taken along lines 22-22 of FIG. 21;

FIG. 23 is a partially sectioned, top plan view of one end of a package for a fiber optic device or component, the other end being essentially a mirror image thereof, illustrating yet another embodiment of the present invention; and

FIG. 24 is a partially sectioned, perspective view of the package shown in FIG. 23;

### DETAILED DESCRIPTION OF PREFERRED EMBODIMENT

Referring now to the drawings wherein the showings are for the purpose of illustrating the preferred embodiment of the invention only, and not for the purpose of limiting same, the drawings show a package 10 for enclosing a fiber optic device or component.

In the embodiment shown, package 10 encloses a fiber optic coupler 12. It will, of course, be appreciated that other types of fiber optic devices may be enclosed within package 10, in accordance with the present invention.

In the art, the term “optic device” generally refers to active elements or apparatus. Whereas, the term “optic component” generally refers to elements or apparatus that are passive. The present invention is applicable to both fiber optic devices and fiber optic components. Accordingly, as used herein, the term “optic device(s)” shall refer both to optic devices and optic components.

Coupler 12 is formed from two or more continuous optical fibers, designated 22, that have been coupled by a conventionally known method. Coupler 12 in and of itself forms no part of the present invention. Coupler 12 has a coupling region, designated 12a. Each fiber has an outer jacket or buffer 24 that surrounds an inner glass fiber 26. As is conventionally understood, jacket or buffer 24 of fibers 22 is removed along a portion of their length to facilitate coupling.

Package 10 is basically comprised of an inner, glass housing 30 contained within an outer protective sleeve 90. Housing 30 is comprised of a first housing section 32 and a second housing section 52. In the embodiment shown, first housing section 32, best seen in FIG. 10, is basically an elongated rod having a semi-cylindrical base portion 32a from which extends two spaced-apart leg portions 32b. Leg portions 32b have flat, outer surfaces that are parallel to each other and sloping inner surfaces. The sloping inner surfaces of leg portion 32b and a planar surface on base portion 32a define a groove 34, best seen in FIG. 5, that extends along the length of first housing section 32. Housing section 32 is provided as a support substrate to support coupler 12. In the embodiment shown, coupler 12 is mounted to first housing section 32 by a glass-based bonding composition 44. Composition 44 is comprised essentially of glass powder and a volatile solvent in a slurry form. The slurry is allowed to dry by allowing the volatile solvent to evaporate, resulting in a generally solid mass that is softened, preferably by a laser, to bond glass fibers 26 of optical fibers 22 to first housing section 32. In this respect, bonding composition 44 and housing sections 32 and 52 are preferably formed of glass having similar physical properties, i.e., coefficient of thermal expansion, as the glass that form fibers 22. A suitable glass-based bonding composition is disclosed in prior U.S. Pat. Nos. 5,500,917 and 5,682,453, both to Daniel et al., the disclosures of which are expressly incorporated herein by reference.

Second housing section 52 is a glass or quartz component dimensioned to cap and/or cover a major portion of first housing section 32. In the embodiment shown, second housing section 52 has a U-shaped cross defined by a base portion 52a and two spaced-apart leg portions 52b. A generally rectangular slot 54 is formed between leg portions 52b, and extends along the length of second housing section 52. Slot 54 is dimensioned to receive first housing section 32. Housing sections 32, 52 are preferably dimensioned such that the outer surfaces of leg portions 32b of first housing section 32 mate closely to the inner surfaces of leg portions 52b of second housing section 52, as illustrated in FIGS. 4 and 6. As best seen in FIGS. 4-7, leg portions 52b are dimensioned to extend beyond base portion 32a of first housing section 32 so as to form axially extending grooves or troughs 62 between leg portions 52b of second housing section 52 and base portion 32a of first housing section 32. Second housing section 52 is preferably shorter than first housing section 32 such that portions of first housing section 32 extend beyond each end of housing section 52. When housing sections are joined together, groove 34 in first housing section 32 defines a continuous passage through housing 30. The ends of the passage define openings in housing 30, and optical fibers 22 extend from housing 30 through the openings.

To secure housing sections 32, 52 to each other, beads 72 of glass-based material are disposed along grooves 62, as best seen in FIGS. 3 and 6. Beads 72 extend continuously along the bottom of base portion 32 of housing section 32 and includes bead sections 72a that extend around the end faces of housing section 52 where housing section 32 extends therefrom, as best seen in FIGS. 5 and 7. Beads 72 communicate with a mass 74 of glass material that fills the openings at the ends of housing 30. Beads 72 and mass 74 are preferably formed from the glass-based bonding composition previously described and disclosed in U.S. Pat. Nos. 5,500,917 and 5,682,453.

The consistency of the glass-based bonding material may be varied based upon the amount of volatile solvents in the bonding composition. When filling openings 58, the glass-based bonding composition preferably has a thicker consistency than the consistency required to fill troughs or grooves 62. With the glass-based bonding composition disposed within the opening(s) and along groove 62, intense energy, preferably in the form of a laser, is applied to heat the bonding composition 44. The glass-based bonding composition 44 essentially softens and fuses to form a hermetic seal between each of the glass components, i.e., between first housing section 32 and second housing section 52, and between housing sections 32, 52 and inner glass fibers 26. When softened, glass-based bonding composition 44 essentially forms glass beads 72 and mass 74 that closes the openings at the ends of housing 30 and hermetically seals coupler 12 therein. The glass-based bonding composition surrounds inner glass fibers 26 that extend through the openings.

It will, of course, be appreciated that sealing housing 30 may be performed in several, successive steps, wherein one or more lengths of beads 72 or bead sections 72a or mass 74 may be formed in a given step.

As indicated above, the glass-based bonding composition may include a volatile solvent. It has been found that during the lasing of the bonding composition, gaseous by-products, i.e., smoke, result from the burning of the volatile solvents and binder materials. Gaseous by-products within housing 30 have a deleterious effect on the performance of coupler 12 if it lands on the coupling region of the coupler.

To prevent gaseous by-products, vapors or other materials from entering the interior of housing 30, a barrier 82 is formed within the passage defined by groove 34 in housing section 32. Barrier 82 is disposed between coupling region 12a and the ends of housing section 52, and completely obstructs the passage defined by groove 34. Barrier 82 may be formed after housing sections 32, 52 are joined, but is preferably formed before assembly of housing sections 32, 52.

In this respect, barrier 82 is preferably formed a material capable of withstanding the high temperatures experienced by the glass during the lasing of the glass-based composition forming beads 72 and mass 74. Preferably, barrier 82 is also somewhat resilient and will deform slightly when housing sections 32, 52 are joined.

Barrier 82 may be formed of a thermosetting or thermoplastic polymer, but in a preferred embodiment, is formed of epoxy or urethane. More preferably, barrier 82 is formed of a curable material, wherein a mass of the curable material may be inserted in groove 34 of first housing section 32, prior to its assembly with second housing section 52. A sufficient amount of the curable material is inserted in groove 34 to overfill groove 34, wherein when second housing section 52 is joined to first housing section 32, the entire passage within housing 30 is filled, and excess material is spread longitudinally through groove 34. With housing sections 32, 52 joined, the material within the passage of housing 30 is cured, thereby forming a barrier 82 between coupler region 12a and the end of housing 30 where mass 74 is to be formed. With barrier 82 disposed between coupling region 12a and an end of housing 30, the opening at the end of housing 30 may be sealed using a glass-based bonding composition, as described above. Barrier 82 will prevent gaseous by-products or impurities from contaminating coupler region 12a.

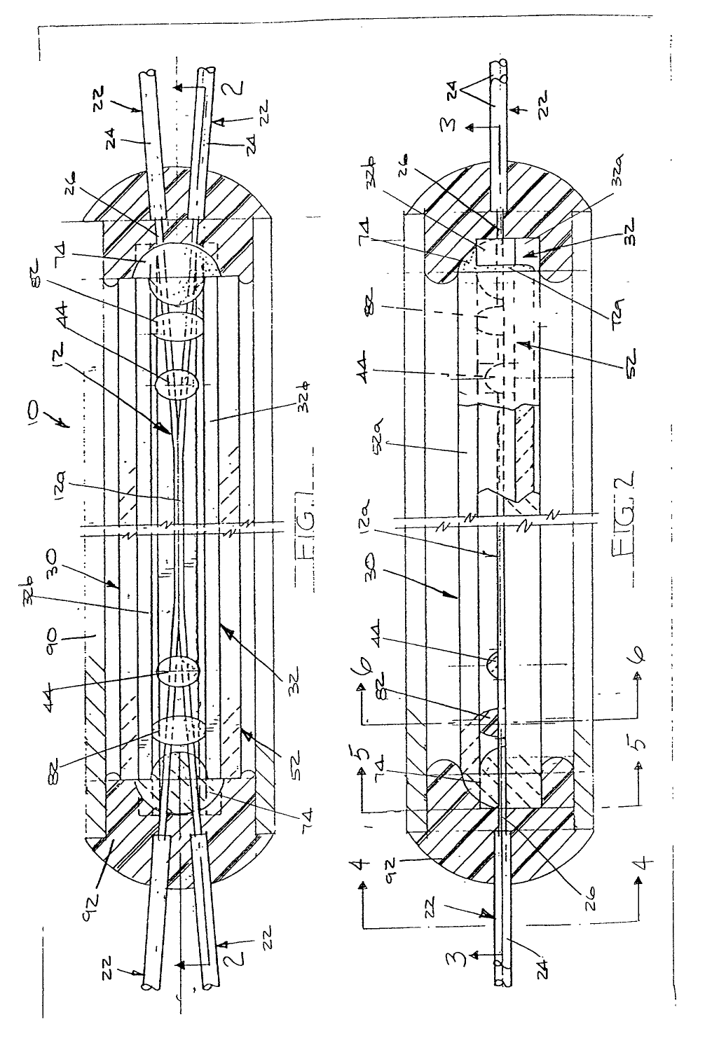

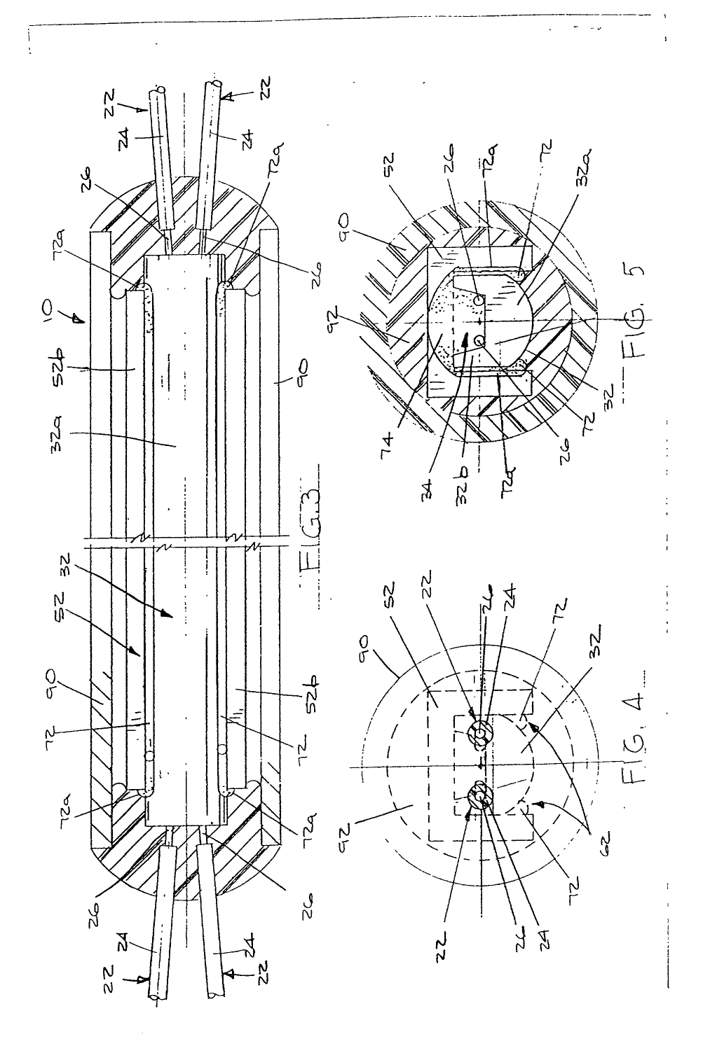

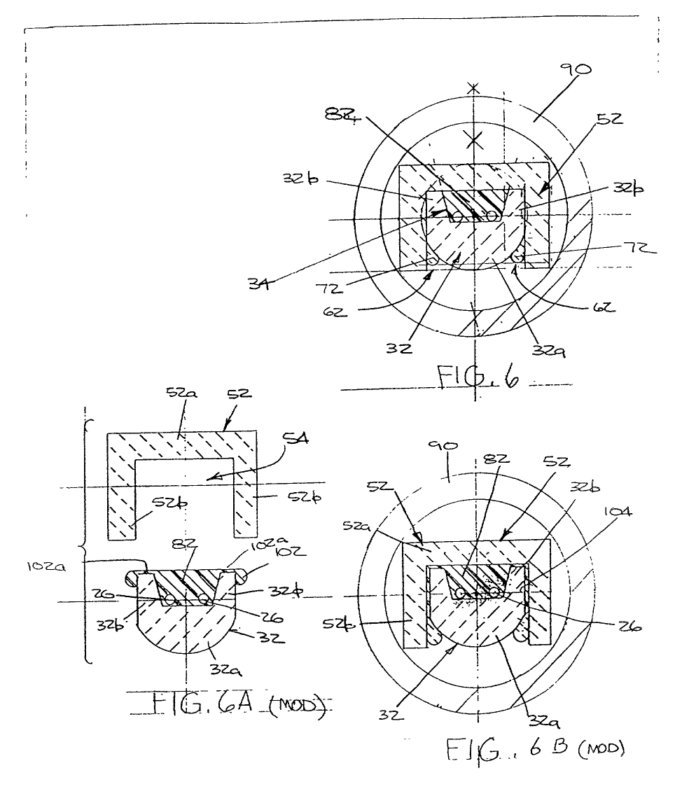

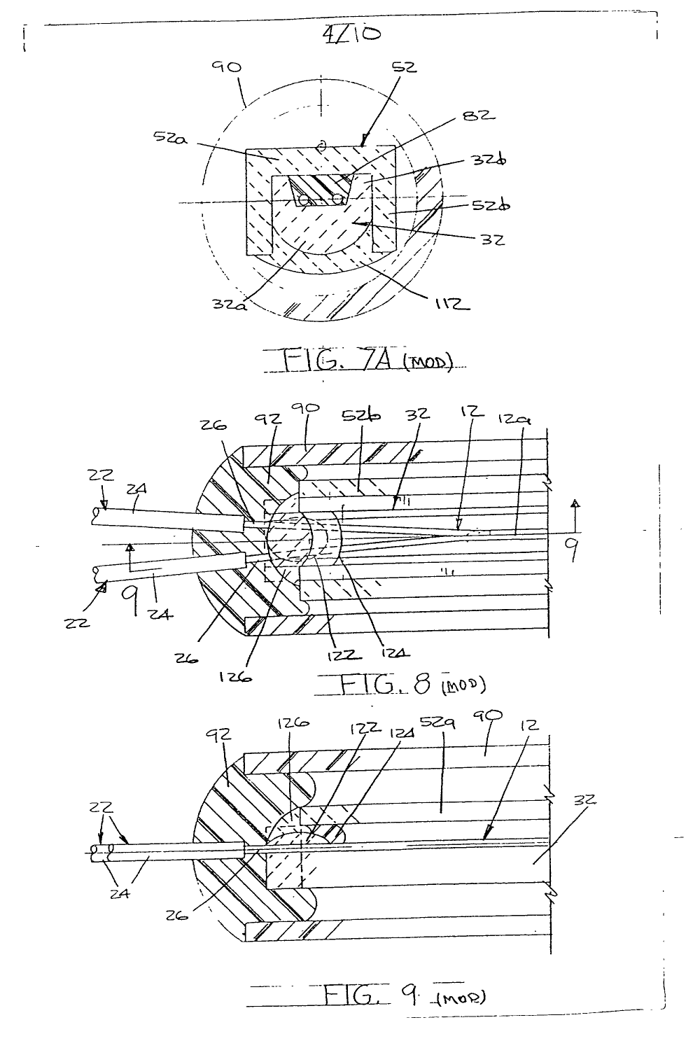

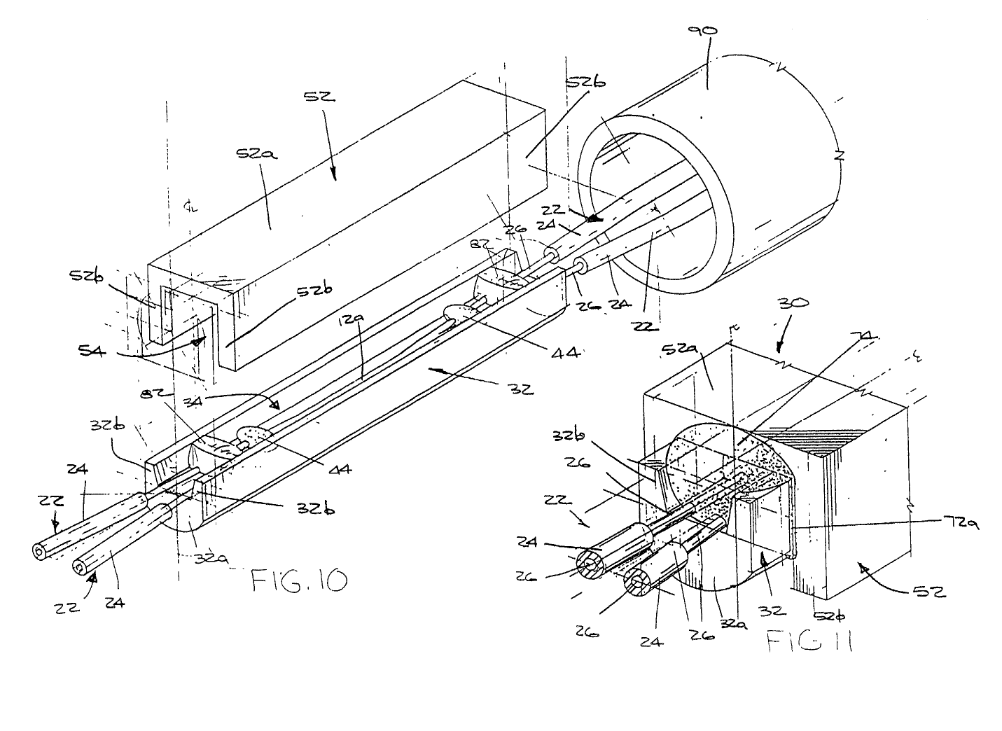

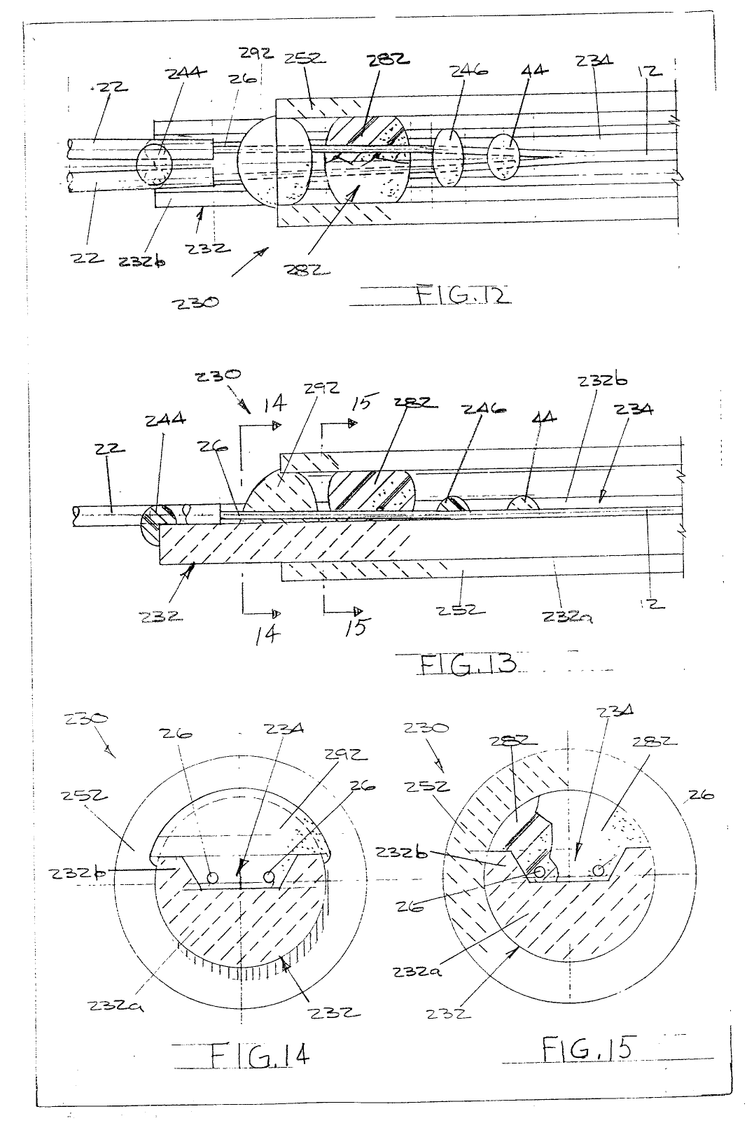

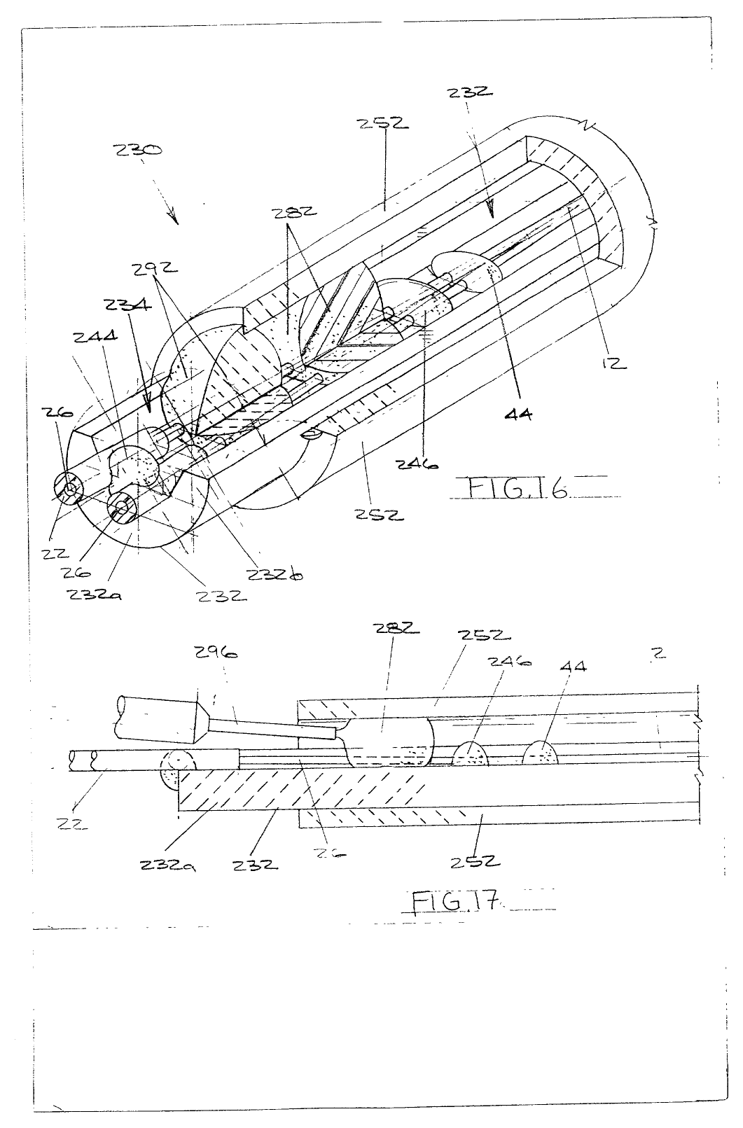

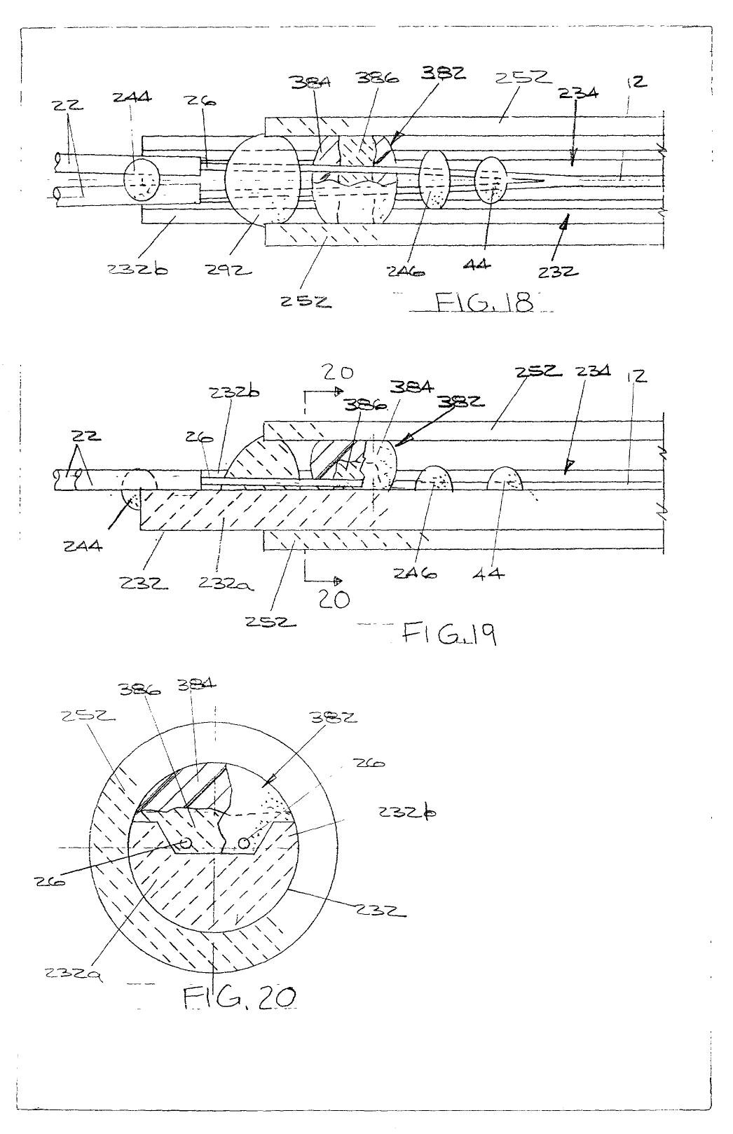

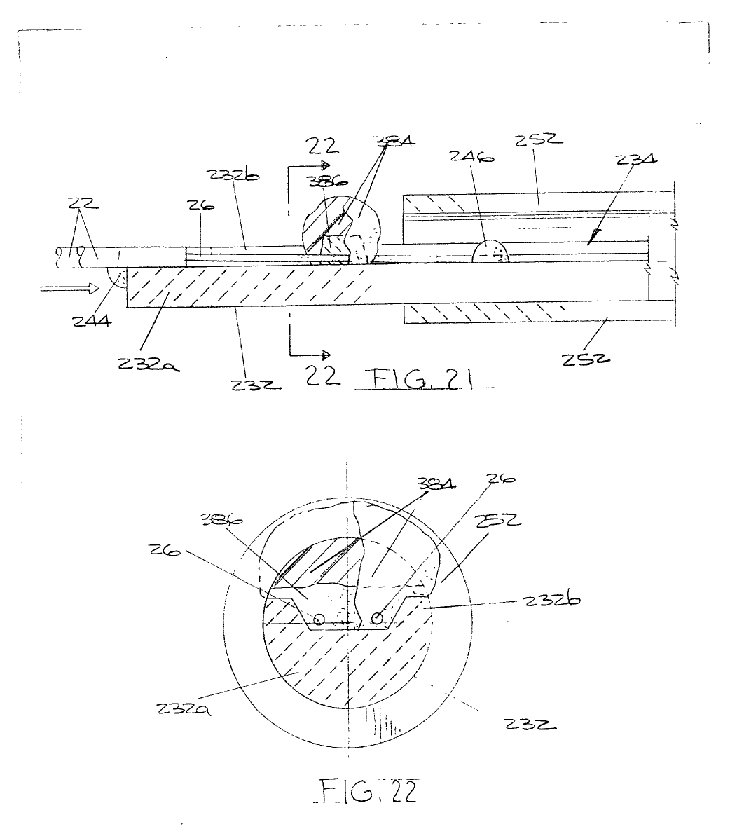

After assembly of housing 30, an outer metallic sleeve 90 is positioned to encase glass housing 30. In the embodiment shown, outer sleeve 90 is cylindrical in shape and has an inner diameter slightly larger than the outer dimensions of housing 30. Outer sleeve 90 is preferably formed of a metal or plastic to provide protection to housing 30. In a preferred embodiment of the present invention, outer sleeve 90 is preferably formed of INVAR® that is an alloy comprised of nickel and steel. As shown in FIGS. 1 and 2, outer sleeve 90 is longer than housing 30. Outer sleeve 90 preferably has a length such that the ends of outer sleeve 90 will surround and enclose at least a portion of the jacket or buffer 24 of optical fibers 22. The ends of outer sleeve 90 are preferably filled with an adhesive/sealant 92, such as a silicon-based material manufactured by Dow Corning® under the trade designation 3145 Mil-A-46146. Adhesive/sealant 92 preferably fills the space defined by outer sleeve 90 thereby capturing a portion of jacket or buffer 24 of fibers 22. Adhesive/sealant 92 thereby provides support for optical fibers 22 so as to relieve strain on glass fiber 26 that would exist in absence of adhesive/sealant 92.

The present invention thus provides a package for a fiber optic device or component that hermetically seals coupling region 12a from external environmental conditions. Since a glass-to-glass bond exists between the respective glass housing sections 32, 52, and between housing sections 32, 52 and the glass fibers 26 that extend therethrough, penetration of water vapor or some component, constituent or by-product of water vapor, into the interior of housing 30 and the area surrounding coupling region 12a is prevented or at least greatly retarded.

The present invention has heretofore been described with respect to a preferred embodiment. FIGS. 6A and 6B show an alternate method of assembling housing sections 32, 52 to seal the passage defined between housing sections 32, 52. In FIG. 6A, beads 102 of a curable material, preferably the same material forming barriers 82, are applied along the length of housing section 32 at the upper edge of the outer surfaces of leg portions 32b of housing section 32. Where bead 102 is near to the material forming barrier 82, a bead section 102a may extend over into contact with barrier 82. With bead 102 in place on housing section 32, when housing section 52 is placed thereon, as illustrated in FIG. 6B, the curable material forming bead 102 is drawn between leg portions 32b of housing section 32 and leg portions 52b of housing section 52. When cured, the material forms a barrier 104 preventing gaseous by-products or other particles from penetrating between housing sections 32, 52 when glass beads 72 are formed along grooves 62. This method of sealing of housing sections 32, 52 may or may not be required depending upon the dimensional fit between housing sections 32, 52.

Referring now to FIG. 7A another method of sealing the length of housing sections 32, 52 is shown. In FIG. 7A, instead of applying bead 72 in groove 62, a single, large bead 112 covers the entire base portion 32a of housing section 32 and the ends of leg portions 52b of housing section 52. With the embodiment shown in FIG. 7A, because of the larger mass of glass material forming bead 112, and the greater amounts of heat required to soften such mass, sealing housing sections 32, 52, as shown in FIGS. 6A and 6B, may be desirable.

Referring now to FIG. 8, another embodiment of the invention is shown, wherein glass fibers 26 of optical fibers 22 are secured to housing section 32 by a relatively large bead 122 of glass-based bonding composition near the end of housing section 32. As seen in FIG. 8, bead 122 closes a substantial portion of the opening at the end of housing 30. A barrier 124 formed as heretofore described, is disposed to one side of bead 122 to seal the passage within housing 30. A second bead 126 of the glass-based bonding composition is formed over bead 122 to close the opening at the end of housing 30. FIG. 8 thus illustrates how the same glass-based material used to secure fibers 26 to substrate 32 may also be used to close the opening defined between housing section 32 and housing section 52.

Referring now to FIGS. 12-17, a glass housing 230 illustrating another embodiment of the present invention is shown. Housing 230 is comprised of a first housing section 232 and a second housing section 252. First housing section 232 is essentially the same as first housing section 32, as heretofore described. In this respect, first housing section 232 is basically an elongated, glass or quartz rod having a semi-cylindrical base portion 232a and two, spaced-apart leg portions 232b that define a groove 234.

A coupler 12 as heretofore described, is mounted to first housing section 232 by a glass-based bonding composition 44. Beads 244, 246 of epoxy or urethane may be used to temporarily secure optical fiber 22 and glass fiber 26, respectively, to first housing section 232 prior to application of glass-based bonding composition 44.

Second housing section 252 is a glass or quartz tube dimensioned to receive first housing section 232 in close mating fashion, as shown in the drawings. Second housing section 252 is shorter than first housing section 232, wherein the distal ends of first housing section 232 extend beyond second housing section 252. A barrier material 282 is disposed in the passage or opening defined by groove 234 between first housing section 232 and second housing section 252. Barrier material 282 is provided to prevent gaseous by-products, vapors or other materials from entering the interior of housing 230. Barrier 282 may be formed of a thermosetting or thermoplastic material, as heretofore described, but in a preferred embodiment, is formed of epoxy or urethane. FIG. 17 schematically illustrates a method of injecting an epoxy or urethane into second housing section 252 to form barrier 282 by means of a dispensing tube 296. The opened end of second housing section 252 is sealed by a bead 292 that is formed of a glass-based bonding composition, as heretofore described. Bead 292 may be extended around base portion 232a to seal the seam that exists between base portion 232a of first housing section 232 and second housing section 252.

Housing 230 is preferably enclosed within an outer metallic sleeve (not shown in FIGS. 12-17) whose ends are filled with an adhesive/sealant that provides strain relief to optical fiber 22, as heretofore described.

Referring now to FIGS. 18-22, an alternate method of forming a barrier within second housing section 252 is shown. (In FIGS. 18-22, components like those described in FIGS. 12-17 bear like reference numbers). A barrier 382 is formed from a resilient, small celled, foam element 384 that is adhered to first housing section 232 by an adhesive 386. As best seen in FIGS. 21 and 22, foam element 384 is preferably larger than the opening between first housing section 232 and second housing section 252, such that when first housing section 232 is slid into second housing section 252, foam element 384 compresses and fills the opening between first housing section 232 and second housing 252. Glass bead 292 seals second housing section 252, as in the prior embodiment. Adhesive 386 may be any adhesive compatible with foam element 384.

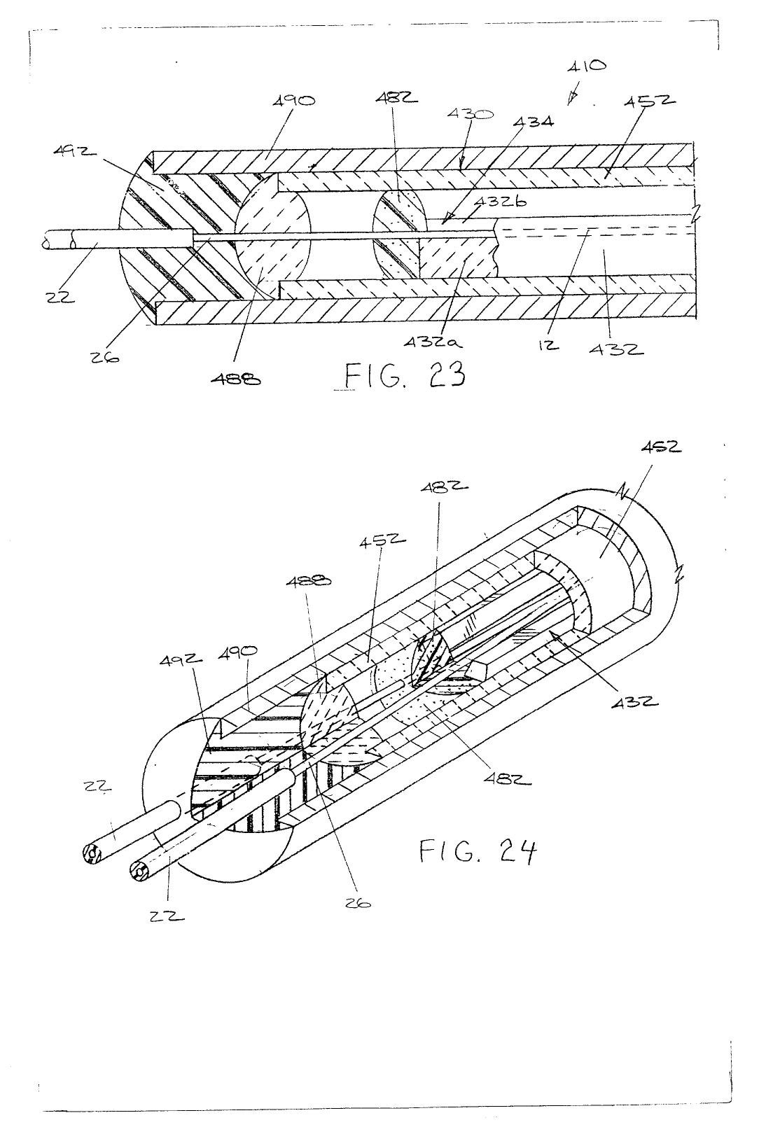

Referring now to FIGS. 23 and 24, a package 410 illustrating yet another embodiment of the present invention is shown.

Package 410 includes a housing section 430 that is comprised of a first housing section 432 and a second housing section 452. First housing section 432 is essentially the same as first housing sections 32 and 232, as heretofore described. In this respect, first housing section 432 is basically an elongated, glass or quartz rod having a semi-cylindrical base portion 432a and two, spaced-apart leg portions 432b that define a groove 434. A coupler 12 as heretofore described, is mounted to first housing section 432. First housing section 432 is dimensioned to be received within second housing section 452. Second housing section 452 is a glass or quartz tube that is longer than first housing section 432 such that first housing section 432 is totally disposed within second housing section 452. A barrier material 482 is inserted within second housing section 452 to seal the opening defined by second housing 452. Barrier material 482 may be formed of a thermosetting or thermoplastic material, as heretofore described, but in a preferred embodiment, is formed of an epoxy or urethane. Barrier material 482 may be injected into second housing section 452, as heretofore described. Barrier material 482 is provided to prevent gaseous by-products, vapors or other materials from entering the interior housing 430. As shown in FIGS. 23 and 24, glass fibers 26 extend through barrier 482. The end of second housing section 452 is closed by a bead 488 that is formed of a glass-based bonding material, as heretofore described. Bead 488 totally encloses the end of second housing section 452. Housing 430 is enclosed within an outer metallic sleeve 490. Sleeve 490 is preferably formed of a metal or plastic to provide protection to housing 430. In a preferred embodiment of the present invention, outer sleeve 490 is preferably formed of INVAR® that is an alloy comprised of nickel and steel. The outer ends of sleeve 490 are preferably filled with an adhesive/sealant 492, such as a silicon-based material, as heretofore described. Adhesive/sealant 492 preferably fills the space defined by outer sleeve 490 and captures a portion of the jacket or buffer 24 of fibers 22, so as to provide support for optical fibers 22 and to relieve strain on glass fiber 26.

Other modifications and alterations will occur to others upon their reading and understanding of the specification. For example, in the embodiments described heretofore, a glass-based bonding composition, as disclosed in U.S. Pat. Nos. 5,500,917 and 5,682,453, was used to secure and seal housing sections 32, 52. Solid glass elements may also be used to seal housing sections 32, 52. For example, two glass rods or glass fibers may be formed to lie in groove 62 between first housing section 32 and second housing section 52. The glass rods or fibers are preferably formed of glass having the same physical properties, i.e., coefficient of thermal expansion, as the glass forming housing sections 32, 52. The glass rods may be placed within grooves 62, instead of the glass-bonding composition, and be lased, as described above, to form the glass bead between housing sections 32, 52. It is intended that all such modifications and alterations be included insofar as they come within the scope of the invention as claimed or the equivalents thereof.

Having described the invention, the following is claimed:

1. A package for a fiber optic device or component, comprised of:
an elongated support substrate for supporting an optical device or component, said optical device or component having at least one optical fiber extending therefrom, said optical fiber having an inner glass cladding surrounded by an outer buffer;
an elongated glass tube dimensioned to receive said support substrate, said tube having open ends, said at least one optical fiber extending through one of said open ends with said outer buffer removed from said optical fiber in the vicinity of said open end;
a glass seal sealing the open ends of said tube; and
a barrier disposed between said substrate and said tube, said barrier surrounding said at least one optical fiber and being disposed within said tube between said optical device or component and said glass seal to form a barrier therein.

2. A package for a fiber optic device or component as defined in claim 1, wherein said barrier means is a polymeric material.

3. A package for a fiber optic device or component as defined in claim 2, further comprising an outer sleeve encasing said glass tube.

4. A package for a fiber optic device or component as defined in claim 3, wherein said outer sleeve is formed of INVAR®.

5. A package for a fiber optic device or component as defined in claim 4, wherein said outer sleeve is cylindrical in shape.

6. A package for a fiber optic device or component as defined in claim 5, wherein said optical device or component is a coupler.

7. A package for a fiber optic device or component as defined in claim 4, wherein said glass seal is formed from a glass-based bonding composition including glass powder having physical properties similar to the glass forming said optical fiber.

8. A package for a fiber optic device or component as defined in claim 1, wherein said substrate is an elongated glass rod having leg portions extending from a semi-cylindrical base portion, said leg portion defining a groove for receiving said optical device or component.

9. A package for a fiber optic device or component as defined in claim 1, wherein a seam is formed between said substrate and said tube, and a generally continuous glass bead seals said seam.
